(19) United States
(12) Patent Application Publication
(10) Pub. No.: US 2007/0238829 A1
(43) Pub. Date: Oct. 11, 2007

(54) MANUFACTURE OF STABLE SILICONE EMULSION

(75) Inventor: Amit Kumar Paul, Kolkata (IN)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/762,433

(22) Filed: Jun. 13, 2007

Related U.S. Application Data
(63) Continuation of application No. PCT/EP05/13174, filed on Dec. 8, 2005.

(30) Foreign Application Priority Data
Dec. 15, 2004 (IN) 818/KOL/2004

(51) Int. Cl. C08L 83/04; C08G 77/04

(52) U.S. Cl. 524/588; 524/837

(57) ABSTRACT

A two stage process for making large particle size silicone oil emulsions employs a surfactant with an HLB of 4 to 9.5 and an anionic thickener in a first mixing step at elevated temperature, and adding further emulsifier and mixing at a lower temperature. Emulsions stable against elevated temperature storage and freeze/thaw cycles for extended periods, and having an average particle size of 1-100 μm are obtained without process complexity or the need for high shear mixing.

### CROSS-REFERENCE TO RELATED APPLICATIONS

This application is a continuation of PCT Appln. No. PCT/EP2005/013174 filed Dec. 8, 2005 which claims priority to Indian application 818/KOL/2004 filed Dec. 15, 2004.

### BACKGROUND OF THE INVENTION

1. Field of the Invention

The present invention relates to a process for making stable and high particle size silicone emulsions involving a selective combination of organopolysiloxanes, emulsifiers and water, in a single process. The process is simple and cost-effective, and can be easily adapted for large scale production of stable high particle silicone emulsions for diverse beneficial end uses and applications. Importantly, the silicone emulsions produced by the process of this invention have average particle sizes in the range of 1-100 microns (D50 value) with a narrow particle size distribution, are highly stable, and have been found to have especially advantageous and beneficial uses in conditioners for shampoo and like applications.

2. Description of the Related Art

It is well known to provide silicone emulsions with varying particle size to suit different end applications and uses.

EP 0 463 431 A2 discloses a process where a silicone oil-in-water emulsion is formed mechanically by forming initially a thick phase emulsion by combining and shearing the silicone, a non-ionic surfactant having an HLB value of 10-19, and water. Thereafter, a further non-ionic surfactant is added having a selective HLB of 1.8-15.0 with or without other anionic and cationic surfactants. Subsequent shearing of the mix resulted in a reduced silicone oil particle size of less than 0.35 microns (350 nanometers). Silicone emulsions with such small particle sizes have limited application.

In particular, the particle size of the silicone emulsion does have an effect on the end use application, for example in hair care applications. For applications such as conditioners and the like for hair care, the emulsion is required to be destabilized for beneficial use/application. It is found that the higher the particle size, the faster is the breaking or desired destabilization of the emulsion for increased deposition of the beneficial silicone agent on the hair.

U.S. Pat. No. 5,302,658 is directed to a process for the manufacture of silicone emulsions having a high silicone oil particle size of 1-100 microns. In particular the process is stated to involve a particular sequence of manipulative steps to achieve the desired high particle size of the emulsion. Importantly, the process requires adding water in numerous small quantities, gradually, to obtain a single emulsion, along with the use of emulsifiers with different HLBs, which ultimately made the process complicated. The complex manipulative steps involved include the initial use of high HLB emulsifiers, which are almost water-soluble, with the highly insoluble polydimethylsiloxane, which creates a tendency toward phase separation of two immiscible components, and the need for a high shear mixing system to bring the two immiscible components into contact. This leads to required manipulative steps to disperse silicone in that high HLB emulsifiers together with water which necessarily make the process complex and difficult to control. Thus, the patent teaches that water addition in a number of steps is essential for converting the organopolysiloxane in the organopolysiloxane-surfactant-water mixture from an oil phase to a water dispersible phase. The process further requires the use of a second emulsifier having HLB values of 1.8-15 for stabilizing, and further attention to water addition for achieving a desired particle size. Apart from the above complexities in the process for an emulsion with a particle size range of from 1-100 microns, there is the usual need for further control of distinct physical parameters in intermittent steps in the emulsion process, all of which usually affect the quality of the final emulsion. In fact, it is well known that to control the desired parameters of the final emulsion, the process should include some physical property based quality checking since it is difficult to alter the emulsion quality at the end of the process. No such quality control measures appear to have been proposed in the above process of emulsion manufacture with high particle size in the range of 1-100 micron, and there is thus, apart from the complexities in the manufacture discussed above, always a chance of quality deviation at the end of the process.

Therefore, there is a continuing need in the art to develop process of making emulsions having particle sizes of from 1-100 microns which would be simpler and which can be readily adapted to large scale commercial manufacture of such high particle size silicone emulsions, for diverse applications.

### SUMMARY OF THE INVENTION

It is thus an object of the invention to provide a process of making silicone emulsions having particle sizes from 1-100 microns which is simple and cost-effective, which does not require complex manipulative steps, and which thus can be readily adapted to large scale commercial manufacture of such high particle size silicone emulsions for diverse applications such as in hair care products and the like.

A further object of the invention is directed to providing a simple process of making silicone emulsions having particle size from 1-100 microns which ensures the simplicity of the process, involving simple stirring and selective emulsifiers, thus avoiding the use of complex and cost-extensive machinery.

A yet further object of the present invention is directed to making stable silicone emulsions having particle size range from 1-100 microns following simple steps without any continuous monitoring, or requiring the addition of components in numerous steps, with the completion of the process steps controlled by measuring standard emulsion physical parameters such as viscosity, and not requiring any continuous particle size measurement.

A still further object of the invention is directed to a process of making silicone emulsions having particle sizes from 1-100 microns which are storage stable and thus favor various and diverse end uses and applications, especially as conditioners in hair care products.

### DETAILED DESCRIPTION OF THE PREFERRED EMBODIMENTS

Thus according to a basic aspect of the present invention there is provided a process for the manufacture of stable and high particle silicone emulsions comprising:
i) providing (a) silicone oil or blends thereof in an amount of 50 to 70% by wt., (b) water in an amount of 10 to 30% by wt., (c) selective non-ionic emulsifier(s) having an HLB in the range of 4.0 to 9.5 in amounts of 1 to 10% by wt. and (d) a selective anionic thickener in an amount of 0.1 to 1% by wt.;
ii) heating the mix of (i) above in the temperature range of 55 to 70° C. and stirring to provide a homogenous mix;
iii) cooling the mix of (ii) above in the temperature range of 20-40° C. and continuing mixing until a desired viscosity in the range of 70,000-1,500,000 cps is attained;
iv) adding further a non-ionic emulsifier having an HLB in the range of 4.0 to 9.0 in an amount of 0.5 to 5%, continuing the mixing in the temperature range of 30-35° C. until a desired viscosity of 20,000 to 65,000 cps is attained, and thereafter adding water for final dilution, with an average particle size in the range of 1 to 100 microns.

Importantly, it is found by way of the invention that one of the critical aspects which enables obtaining such high particle size emulsions following a simple process, is the selective use of emulsifiers to achieve the desired high particle size emulsion. Also the quantity of the emulsifiers has a great role in making the emulsion stable. In particular, in the above process of making high particle organopolysiloxane emulsions, the emulsions are stabilized by use of surfactant(s) having a critical HLB value which help to mix oil and water easily without need for complex manipulative steps or precautions during water addition.

Moreover, the present invention further identifies the importance of the selective use of thickeners, which has a important role in achieving a stable high particle emulsion. In the process, the thickener is selectively used to act as a suspending agent in the emulsion. Anionic thickeners are found to be the best thickening agents to stabilize the emulsions in comparison to other known conventional thickeners. The selective use of thickeners provide for a longer self life of the emulsion system of the invention.

Since the process uses high viscosity blended silicone oils with a small quantity of surfactant, it is important to adapt the process in such a way that the material can be mixed uniformly.

Also the process advantageously allows a simple measurement of viscosity (Brookfield) of the emulsion as a physical parameter to confirm the emulsion formation with desired constitution/high particle size.

Thus the above disclosed process of the invention directed to making high particle size emulsions of an organopolysiloxane or a mixture of polysiloxanes having particle sizes in the range of 1-100 microns involves very simple and selective mixing of components, wherein the effective completion of the stages of emulsion preparation is determined by simple measurement of viscosity of the emulsion system.

In accordance with a preferred aspect of the present invention, the above process for the manufacture of stable and high particle size silicone emulsions is a two stage process comprising:
a first stage comprising providing a silicone oil/blend in a mixing tank in an amount of 50-70% of the total emulsion weight, preferably in the range of 55-65% of the emulsion, adding 10-30% water, and preferably 15-25% of water to the emulsion, a non-ionic emulsifier having an HLB value 4.0-9.5 in amounts of 1-10% of the emulsion, preferably 1-4% of emulsion, or adding emulsifier in a ratio of 20-30:1 fluid to emulsifier, along with 0.1 to 1% thickener; heating all components under mixing conditions in the range of 55° C.-70° C. and continuing stirring until the emulsifier and thickener disperse in the system, generally for a period of 0.5-3 hr, preferably 0.5-1.0 hr with stirring; cooling the mixture to 20-40° C., most preferably 30-35° C., and continuing mixing until a targeted viscosity of the water-oil-surfactant-thickener in the range of 70,000 to 1,500,000 cps is achieved, generally in a period of 2-5 hr, preferably 2-4 hr; and
a second stage comprising adding emulsifier in an amount 0.5% to 5%, preferably 0.5 to 2.5%, relative to the weight of the emulsion, or adding emulsifier in a ratio of 40-45:1 (fluid to emulsifier ratio), the emulsifier having an HLB value between 4.0 to 9.5; continuing mixing at 30-35° C. until a targeted viscosity of the water-oil-surfactant-thickener in the range of 20,000 to 65,000 cps is achieved, generally in a period of from 1-3 hr, preferably 1.0-1.5 hr, while stirring; and after the desired viscosity is achieved, adding the balance of water for final dilution, and optionally biocide in the range of 0.01 to 0.05% by weight to obtain a high particle size emulsion of average particle size in the range of 1-100 microns.

According to the present invention, one of the critical parameters includes the selection of the right emulsifier to achieve the desired high particle size emulsion, since one of the main objectives in the present invention is to produce large particle size emulsions in a simple way, where emulsifier(s) have a great influence in making the process simple. The quantity of the emulsifiers also has a great role in making the emulsion stable. Since the process uses high viscosity blended silicone oil with only a small quantity of surfactant, it is necessary to design the formulation in such a way that material can be mixed uniformly. According to the present invention, it is also important to establish a physical parameter by which it is easy to determine the completion of mixing. Viscosity of the mixture has a great importance in identifying the completion of mixing. In particular, the homogeneity of the dispersion ensures completion of mixing of the first emulsifier and thickener in oil and water systems.

Importantly, the above process for producing high particle size emulsions is not time dependent, because the particle size of the final emulsion is dependent only on the type of emulsifiers and the fluid to emulsifier ratios.

The invention thus provides a process for making stable high particle emulsions from an organopolysiloxane (silicone fluid) or a mixture of organopolysiloxanes (henceforth referred to as “blended silicone fluid”). Blended silicone fluid is a mixture of at least one high viscosity non-volatile organopolysiloxane and at least one low viscosity non-volatile organopolysiloxane, functional polysiloxane, or mixture thereof. Even though the invention is effective for producing high particle size emulsions from a silicone fluid or blended silicone fluid, the invention is not restricted to those fluids, since it has been found that high particle emulsions can also be produced from an amino-functional polysiloxanes, carbonyl-functional polysiloxanes, glycol-functional polysiloxanes, epoxy-functional polysiloxanes, carboxy-functional polysiloxanes or vinyl-functional polysiloxanes, or mixture thereof.

The highly viscous polysiloxanes used in the present inventions have the following structure of Formula I 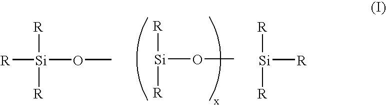
where R, which may differ, is a monovalent hydrocarbon radical and x is an integer from 1000 to 4000.

Examples of R are alkyl radicals such as methyl, ethyl, n-propyl, isopropyl, n-butyl, isobutyl, tert-butyl, n-pentyl, isopentyl, neopentyl, and tert pentyl, hexyl such as n-hexyl, heptyl such as n-heptyl, octyl such as n-octyl and isooctyl such as 2,2,4-trimethylpentyl, nonyl such as n-nonyl, decyl such as n decyl, dodecyl such as n-dodecyl, octadecyl such as n-octadecyl; alkenyl such as vinyl and allyl, cycloalkyl such as cyclopentyl, cyclohexyl, cycloheptyl and methyl cyclohexyl, aryl such as phenyl, naphthyl, anthryl and phenanthryl; alkylaryl such as o-, m-, p-tolyl, xylyl and ethylphenyl; and aralkyl such as benzyl, and c- and P-phenylethyl, of which methyl, ethyl, n-propyl, and isopropyl are preferred, and methyl is particularly preferred.

The Low viscosity non-volatile polysiloxane having the following Formula II 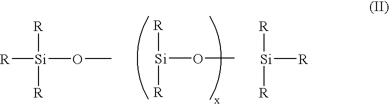
where R, which may differ, is a monovalent hydrocarbon radical and x is an integer from 75 to 700.

Examples of R are alkyl radicals such as methyl, ethyl, n-propyl, isopropyl, n-butyl, isobutyl, tert-butyl, n-pentyl, isopentyl, neopentyl, and tert-pentyl, hexyl such as n-hexyl, heptyl such as n-heptyl, octyl such as n-octyl and isooctyl such as 2,2,4-trimethylpentyl, nonyl such as n-nonyl, decyl such as n-decyl, dodecyl such as n-dodecyl, octadecyl such as n-octadecyl; alkenyl such as vinyl and allyl, cycloalkyl such as cyclopentyl, cyclohexyl, cycloheptyl and methyl cyclohexyl, aryl such as phenyl, naphthyl, anthryl and phenanthryl; alkylaryl such as o-, m-, p-tolyl, xylyl and ethylphenyl; and aralkyl such as benzyl, and α- and β-phenylethyl, of which methyl, ethyl, n-propyl, and isopropyl are preferred, and methyl is particularly preferred.

The high viscosity non-volatile polysiloxane according to structure (I) preferably has a viscosity of between 60,000 cps and 1 million cps. Preferably, the viscosity of the high viscosity non-volatile polysiloxane is between 100,000 cps and 600,000 cps. According to the structure (II) of low viscosity polysiloxane, the oil viscosity preferably lies between 100 cps and 5000 cps, more preferably between 350 cps to 2000 cps.

According to the present invention, the ratio of two fluids in the blended silicone is important in use as a conditioner in shampoo. Generally, the high viscosity to low viscosity ratio in the blended silicones varies from 20:80 to 80:20. Preferably, the best effect is achieved as a conditioner when the ratio varies from 50:50 to 70:30. According to the present invention, a viscosity of the blended silicone oil varying from 30,000 cps to 100,000 cps imparts optimum conditioning effect in the shampoo.

The functional non-volatile polysiloxane useful according to the present invention has the following Formula III 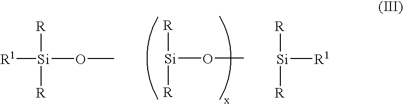
where R¹ is selected from amino-functional groups containing at least one carbon atom; carbonyl-functional groups containing at least one carbon atom; glycol-functional groups containing at least one carbon atom; epoxy-functional groups containing at least one carbon atom; acryloxy-functional groups; chloroalkyl-functional groups; vinyl-functional groups and other functional groups having the formula X—R²— where X is a functional group containing one atom which is not a carbon atom or a hydrogen atom, R² is selected from alkylene groups having at least one carbon atom, and x is an integer from 10-100. Some of the important R² groups have the following formulae but are not limited thereby:

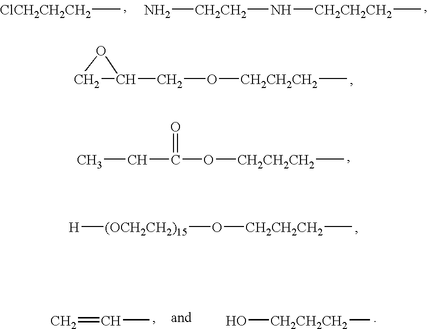

According to the present invention, the process of making high particle size emulsions comprises simple mixing of silicone oil with at least one primary surfactant, thickener and water. It is preferred to mix silicone oil, surfactant, thickener and water in a stainless steel mixer to at least 55° C. and more preferably 55° C.-70° C. After dispersing the thickener, the mixture is cooled to 20-40° C. and most preferably 30-35° C. Stirring is continued while maintaining the temperature at 30-35° C. until a desired viscosity of the emulsion is reached. The second emulsifier is added and stirring is continued while maintaining the temperature at 30-35° C. until the viscosity of the emulsion drops to the desired viscosity. The resulting material is then diluted with rest of the water and biocide to form the high particle size emulsion. The resulting emulsion has an average particle size from 1-100 microns (D50).

It is also preferred that the processing in the first stage of mixing (until first emulsifier and thickener disperse in fluid) is carried out at more than 50° C., and more preferably at temperatures of 55-70° C., at atmospheric pressure. Heat can be applied by electrical means, steam, hot oil, or hot water or any combination thereof. After dispersing of surfactant and thickener in the fluid, the mixture is cooled to 20-40° C. and most preferably 30-35° C. The rest of the mixing process is carried out at 30-35° C., preferably at atmospheric pressure. Higher or lower pressures may of course be used, but atmospheric pressure is preferred.

The components are mixed by simple low shear mixing. Useful low shearing stirring system are illustrated by but not limited to, propeller stirrers, turbine stirrers, pitch blade stirrers, anchor stirrers and others. Also, low shearing means, which can mix the components without generating much shear, can be used in the process of this invention. It is not recommended to use a mixing system which generates high shear, for example a homogenizer. From a capital investment point of view, it is also clear that the process requires only a very economical mixing system, unlike the expensive mixing systems used in the prior art.

The total time required to produce an emulsion having a particle size of 1-100 micron from start to finish is dependent on the design of the stirrer, the loading system of all components and the efficiency of temperature change. Typically, such emulsions can be produced in less than 6 hr. It is important to continue to mix the compositions to achieve the desired viscosity and related properties until the average particle size reaches 1-100 microns.

The selective emulsifier used in the formulation of high particle size emulsions in accordance with the present invention is a non-ionic surfactant having an HLB of 4.0-9.5. Most useful surfactants of this category are polyoxyalkylene alkyl ethers, polyoxyalkylene alkylphenyl ethers, and polyoxyalkylene sorbitan esters. Non-ionic surfactants having an HLB value of 4.0-9.5 are important in the present invention to keep the process simple. Non-ionic surfactants within the HLB value 4.0-9.5 help to easily mix the two different phase components (silicone oil and water) with each other with simple stirring, since these emulsifiers are dispersible in both phases. These emulsifiers also help to form emulsion micelles very rapidly due to their dispersibility advantages.

According to the present invention, suitable thickeners also have an important role in making a stable high particle emulsion. A main criterion of the thickener is to act as a suspending agent in the emulsion. Choice of the right thickener is also an art according to the present invention, since thickener improves the stability of the emulsion significantly. Anionic polycarboxylic acid thickeners have been found to be among the best thickening agents to stabilize the emulsion in comparison to conventional Xantham gum, sodium alginate, gum Arabic, all types of guar gum and all types of cellulose derivatives. Carbopol® 980, and Carbopol® 981; of Noveon are the most useful thickening agents in the present invention to stabilize the emulsion. The quantity of the thickener also has a critical effect to endow longer stability of the emulsion. Generally, 0.1 to 10% thickener in the emulsion is useful to make the emulsion stable for longer periods of time. Preferably, 0.1 to 1% thickener is the optimum quantity for the greatest shelf-life of the emulsion.

Importantly, the stability of the emulsion system of the invention is confirmed by the fact that after achieving the desired viscosity in stage one and stage two, if the material is stirred for more time after achieving the desired viscosity, there is until no effect in the quality of the emulsion.

Further, after preparing the emulsion, during elevated temperature storage, for example in an oven in the range of 45 to 60° C., and most preferably 55° C., for one month, no creaming or separation or deformation of the emulsion is observed. A study consisting of 12 hr freeze/thaw cycles at 10° C./50° C. temperature for one month was also conducted. In this study also, no creaming or separation or deformation of the emulsion is observed.

The details of the invention, its objects and advantages are explained hereunder in greater detail in relation to non-limiting exemplary illustrations of the process:

### EXAMPLE 1

A blended silicone oil containing 40% trimethylsiloxy-terminated dimethylpolysiloxane having a viscosity of 350 cps and 60% trimethylsiloxy-terminated dimethylpolysiloxane having a viscosity of 600,000 cps was mixed together in a mixing tank having an anchor stirrer. This oil was used for making emulsions in the following examples.

### EXAMPLE 2

In the first step of the emulsion process, 4000 g of blended oil from example 1, 1370 g demineralised water (DM water); 13.5 g Carbopol® 980 and 156 g STAL 5 (Grand Organics) were employed. The materials were heated to 60° C. under stirring and stirring was continued until STAL 5 (Grand Organics) and Carbopol® 980 dispersed in fluid and water. Generally, 0.5 hr was required to disperse the components into the water and oil mixture. The mixture was cooled to 30-35° C. and mixing was continued at 30-35° C. until viscosity reached 1,200,000 cps (mPa·s). Generally, 3.5 hr was required to reach the desired viscosity level. In the second stage, 80 g Laffonics 1340 (Laffans, India) was added and mixing continued until the viscosity dropped to 40,000 cps. Generally, 1.0 hr was required to reduce the viscosity of the mixture to the desired level. 1057 g DM water was then added for final dilution of the emulsion, and 3 g Kathon® CG was added as a biocide.

The particle size of the emulsion was measured by a Malvern Mastersizer, resulting in a very narrow particle size distribution having 2.87 micron D10; 10.76 micron D50; 23.74 micron D90 and 41.43 micron D100.

A study of heat stability of the Example 2 emulsion was conducted at 55° C. for one month and no deformation of the emulsion was observed even after one month. The emulsion of Example 2 also showed absolutely perfect behavior when the emulsion was subjected to 12 hr freeze/thaw cycles at 10° C./50° C. temperatures for one month.

### EXAMPLE 3

In the first step of the emulsion process, the 4000 g blended oil from Example 1, 1370 g demineralised water (DM water); 20 g Carbopol® 980 and 200 g STAL 5 (Grand Organics) were employed. The materials were heated to 60° C. under stirring and stirring was continued until STAL 5 (Grand Organics) and Carbopol® 980 dispersed in fluid and water. Generally, 0.5 hr was required to disperse the components into the water and oil mixture. The mixture was cooled to 30-35° C. and mixing was continued at 30-35° C. until the viscosity reached 1,250,000 cps. Generally, 3.5 hr was required to reach the desired viscosity. In the second stage, 98 g Laffonics 1340 (Laffans, India) was added and mixing continued until a viscosity drop to 45,000 cps was achieved. Generally, 1.0 hr was required to reach the desired final viscosity. 975 g DM water was then added for final dilution of the emulsion, and 3 g Kathon® CG as a biocide.

The particle size of the emulsion was measured by a Malvern Mastersizer, resulting in a very narrow particle size distribution having 4.13 micron D10; 17.59 micron D50; 47.88 micron D90 and 58.94 micron D100.

The heat stability of the Example 3 emulsion was studied at 55° C. without observing any deformation of the emulsion, even after one month. The emulsion from Example 3 also showed absolutely perfect behavior when the emulsion was subjected to 12 hr freeze/thaw cycles in 10° C./50° C. temperature for one month.

### EXAMPLE 4

In the first step of the emulsion process, 4000 g blended oil from example 1, 1370 g demineralised water (DM water); 10 g Carbopol® 980 and 200 g STAL 5 (Grand Organics) were employed. The materials were heated to 60° C. under stirring and stirring continued until STAL 5 (Grand Organics) and Carbopol® 980 dispersed in fluid and water. Generally, 0.5 hr was required to disperse the components into the water oil mixture. The mixture was cooled to 30-35° C. and mixing continued at 30-35° C. until the viscosity reached 1,180,000 cps. Generally, 3.0 hr was required to reach the desired viscosity. In the second stage, 98 g Laffonics 1340 (Laffans, India) was added and mixing continued until a viscosity drop to 39,000 cps was observed. Generally, 1.0 hr was required to reduce the viscosity of the mixture to the desired level. 985 g DM water was added for final dilution of the emulsion, and 3 g Kathon® CG as a biocide.

The particle size of the emulsion was measured by a Malvern Mastersizer, resulting in a very narrow particle size distribution having 2.5 micron D10; 10.0 micron D50; 23.61 micron D90 and 35.56 micron D100.

The heat stability of the Example 4 emulsion was studied at 55° C. with no deformation of the emulsion, even after one month. The emulsion from Example 4 also showed absolutely perfect behavior when the emulsion was subjected to 12 hr freeze/thaw cycles at 10° C./50° C. temperatures for one month.

### EXAMPLE 5

In the first step of the emulsion process, 4000 g blended oil from Example 1, 1370 g demineralised water (DM water); 12 g Carbopol® 980 and 200 g Laffonics 1340 (Laffans, India) were employed. The materials were heated to 60° C. under stirring and stirring continued until Carbopol® 980 dispersed in fluid and water. Generally, 0.5 hr was required to disperse the components into the water and oil mixture. The mixture was cooled to 30-35° C. and continued mixing at 30-35° C. until the viscosity reached 1,500,000 cps. Generally, 2.5 hr was required to reach the desired viscosity. In the second stage, 98 g Laffonics 1340 (Laffans, India) was added and mixing continued until the viscosity dropped to 60,000 cps. Generally, 1.0 hr was required to reduce the viscosity of the mixture to the desired level. 983 g DM water was added for final dilution of the emulsion, with 3 g Kathon® CG as a biocide.

The particle size of the emulsion was measured by a Malvern Mastersizer, resulting in a very narrow particle size distribution having 3.44 micron D10; 13.43 micron D50; 30.05 micron D90 and 56.23 micron D100.

The heat stability of the Example 5 emulsion was studied at 55° C., without any deformation of the emulsion, even after one month. The emulsion from Example 5 also showed absolutely perfect behavior when the emulsion was subjected to 12 hr freeze/thaw cycles at 10° C./50° C. temperature for one month.

### EXAMPLE 6

In the first step of the emulsion process, 4000 g blended oil from Example 1, 1370 g demineralised water (DM water); 14 g Carbopol® 980 and 200 g STAL 5 (Grand Organics) were employed. The materials were heated to 60° C. under stirring and stirring continued until STAL 5 (Grand Organics) and Carbopol® 980 dispersed in fluid and water. Generally, 0.5 hr was required to disperse the components into the water and oil mixture. The mixture was cooled to 30-35° C. and mixing continued at 30-35° C. until the viscosity reached 1,300,000 cps. Generally, 3.0 hr was required to reach the desired viscosity. In the second stage, 326 g 30% solution of STAL 5 (Grand Organics) was added and mixing continued until the viscosity dropped to 44,000 cps. Generally, 1.0 hr was required to reach the desired viscosity. 753 g DM water was added for final dilution of the emulsion, with 3 g Kathon® CG as a biocide.

The particle size of the emulsion was measured by a Malvern Mastersizer, resulting in a very narrow particle size distribution having 3.82 micron D10; 20.51 micron D50; 46.3 micron D90 and 76.32 micron D100.

The heat stability of Example 6 emulsion was studied at 55° C. with no deformation of the emulsion, even after one month. The emulsion from Example 6 also showed absolutely perfect behavior when the emulsion was subjected to 12 hr freeze/thaw cycles at 10° C./50° C. temperatures for one month.

### EXAMPLE C7 (COMPARATIVE)

In the first step of the emulsion process, 4000 g blended oil from Example 1, 1370 g demineralised water (DM water); 13.5 g Rhodopol® 23 (Xanthum gum) and 156 g STAL 5 (Grand Organics) were employed. The materials were heated to 60° C. under stirring and stirring continued until STAL 5 (Grand Organics) and Rhodopol® 23 dispersed in fluid and water. Generally, 0.5 hr was required for dispersing the components into the water and oil mixture. The mixture was cooled to 30-35° C. and mixing continued at 30-35° C. until the viscosity reached 1,050,000 cps. Generally, 3.5 hr was required to reach the desired viscosity. In the second stage, 80 g Laffonics 1340 (Laffans, India) was added and mixing continued until the viscosity dropped to 37,000 cps. Generally, 1.0 hr was required to reach the desired viscosity. 1057 g DM water was added for final dilution of the emulsion, with 3 g Kathon® CG as a biocide.

The particle size of the emulsion was measured by a Malvern Mastersizer, resulting in a wide particle size distribution having 0.5 micron D10; 7.88 micron D50; 56.7 micron D90 and 99.4 micron D100.

A study of the heat stability at 55° C. showed separation after eight days. The emulsion also separated after nine days when the emulsion was subjected to 12 hr freeze/thaw cycles at 10° C./50° C. temperatures.

### EXAMPLES 8-10

In the Examples 8 to 10, the same formulation as in Example 2 was used, but only the stirring time in the first stage, the second stage, or both was changed. The particle size of the emulsion for Examples 8-10 were then measured.

| | Stirring | Stirring | | | | |
|---|---|---|---|---|---|---|
| | time in | time in | | | | |
| | the 1^{st} | the 2^{nd} | D10; | D50; | D90; | D100; |
| Example | stage, hr | stage, hr | micron | micron | micron | micron |
| 2 | 3 | 1 | 2.87 | 10.76 | 23.74 | 41.43 |
| 8 | 5 | 1 | 2.92 | 10.8 | 23.4 | 40.5 |
| 9 | 3 | 3 | 2.7 | 11.0 | 22.88 | 41.1 |
| 10 | 5 | 5 | 2.9 | 11.1 | 23.7 | 41.8 |

Also, a study of the heat stability of the emulsions of Examples 8-10 at 55° C. resulted in no observed deformation of the emulsions even after one month. Emulsions from Examples 8-10 also showed absolutely perfect behavior when the emulsion was subjected to 12 hr freeze/thaw cycles at 10° C./50° C. temperatures for one month.

### EXAMPLE C11 (COMPARATIVE)

In the first step of the emulsion process, 4000 g blended oil from Example 1, 1370 g demineralised water (DM water); 13.5 g Carbopol® 980 and 156 g Brij 35 (ICI product) were employed. The materials were heated to 60° C. under stirring and stirring continued until Brij 35 and Carbopol® 980 dispersed in fluid and water. Generally, 0.5 hr was required to disperse the components into the water and oil mixture. The mixture was cooled to 30-35° C. and mixing continued at 30-35° C. until the viscosity reached 70,000 cps. Generally, 3.0 hr was required to reach the desired viscosity. In the second stage, 98 g Dehydrol LS-2 (Henkel product) was added and mixing continued until the viscosity dropped to 35,000 cps. Generally, 1.0 hr was required to reach the desired viscosity. 1057 g DM water was added for final dilution of the emulsion, and 3 g Kathon® CG as a biocide.

The particle size of the emulsion was measured by a Malvern Mastersizer, resulting in a wide particle size distribution having 0.7 micron D10; 5.0 micron D50; 65.8 micron D90 and 240.9 micron D100.

A study of the heat stability at 55° C. showed emulsion separation after one day. The emulsion also separated after one days when the emulsion was subjected to 12 hr freeze/thaw cycles at 10° C./50° C. temperatures.

### EXAMPLE C12

In the first step of the emulsion process, 4000 g blended oil from Example 1, 1370 g demineralised water (DM water); 13.5 g Carbopol® 980 and 400 g STAL 5 (Grand Organics) were employed. The materials were heated to 60° C. under stirring and stirring continued until STAL 5 (Grand Organics) and Carbopol® 980 dispersed in fluid and water. Generally, 0.5 hr was required to disperse the components in the water and oil mixtures. The mixture was cooled to 30-35° C. and mixing continued at 30-35° C. until the viscosity reached 400,000 cps. Generally, 3.0 hr was required to reach the desired viscosity. In the second stage, 200 g Laffonics 1340 was added and mixing continued until the viscosity dropped to 130,000 cps. Generally, 1.0 hr was required to reach the desired viscosity. 680 g DM water was added for final dilution of the emulsion, and 3 g Kathon® CG as a biocide. Viscosity of the final product was 70,000 cps.

The particle size of the emulsion was measured by a Malvern Mastersizer, resulting in a wide particle size distribution having 0.08 micron D 10; 0.75 micron D50; 10 micron D90 and 14 micron D100.

Due to the high content of emulsifier, the particle size of the emulsion obtained was lower than 1 micron.

The above results demonstrate clearly the importance of the selective use of emulsifier to achieve the desired high particle size emulsion. Also the quantity of the emulsifiers has a great effect in making the emulsions stable. In particular, as demonstrated above in the process of making high particle organopolysiloxane emulsions, the emulsions could be stabilized by use of selective amounts of surfactant/surfactants having a critical HLB value that help to mix oil and water easily without need for complex manipulative steps or criticality of water addition. Moreover, the selective use of thickener, which has a very important role to achieving a stable high particle emulsion, is further demonstrated by the above examples. Anionic thickeners are found to be the best thickening agents to stabilize the emulsion as compared to other known conventional thickeners. The selective use of thickeners provides for longer self life of the emulsion system of the invention.

It is thus possible by way of the invention to provide a process of making silicone emulsions having an average particle size from 1-100 micron which would be simple, cost-effective, do not require the complex manipulative steps, and thus can be readily adopted for large scale commercial manufacture of such high particle size silicone emulsions for diverse applications such as in hair care products and the like.

It is possible to obtain a variety of high particle emulsions based on selective emulsifiers, silicone fluid compositions and ratio of fluid to emulsifiers following the simple two stage process of making high particle emulsion of the invention for diverse end use applications including in hair care products and the like and the scope of the invention may be governed keeping in view such beneficial aspects of the present process.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for the manufacture of stable and high particle size silicone emulsion, comprising:
i) providing (a) silicone oil or a blend thereof in an amount of 50 to 70% by wt., (b) water in an amount of 10 to 30% by wt., (c) non-ionic emulsifier having an HLB in the range of 4.0 to 9.5 in an amount of 1 to 10% by wt., and (d) anionic thickener in an amount of 0.1 to 1% by wt.;
ii) heating a mixture of (i) above in a temperature range of 55 to 70° C. and stirring to provide a homogenous mixture;
iii) cooling the homogeneous mixture of (ii) to a temperature in the range of 20-40° C. and continuing mixing until a Brookfield viscosity in the range of 70,000-1,500,000 mPa·s is attained;
iv) adding a further non-ionic emulsifier having an HLB in the range of 4.0 to 9.0 in an amount of 0.5 to 5%, and continuing mixing in the temperature range of 30-35° C. until a Brookfield viscosity of 20,000 to 65,000 mPa·s is attained, and thereafter optionally adding water for final dilution,
wherein the D50 average particle size of the dispersed phase is in the range of 1 to 100 microns.

2. The process of claim 1 wherein said non-ionic emulsifiers of step (i) comprise surfactant or surfactant combinations having an HLB value which allows for mixing oil and water phases without high shear.

3. The process of claim 1 wherein said blended silicone fluid comprises a mixture of at least one viscous non-volatile organopolysiloxane with a viscosity in the range of 60,000 mPa·s to 1,000,000 mPa·s and at least one low viscosity non-volatile organopolysiloxane with a viscosity of 100 mPa·s to 5,000 mPa·s; wherein said organopolysiloxanes are optionally functionalized with reactive groups.

4. The process of claim 1 wherein the high particle size emulsion comprises a silicone selected from amino-functional polysiloxanes, carbonyl-functional polysiloxanes, glycol-functional polysiloxanes, epoxy-functional polysiloxanes, carboxy-functional polysiloxanes, vinyl-functional polysiloxanes, and mixtures thereof.

5. The process of claim 3 wherein the viscous polysiloxane has the structure of Formula I 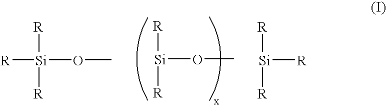
where R, which are the same or different, are monovalent hydrocarbon radicals and x is an integer from 1000 to 4000.

6. The process of claim 5 wherein in said viscous polysiloxane structure of Formula I, R comprise alkyl radicals selected from the group consisting of methyl, ethyl, n-propyl, isopropyl, n-butyl, isobutyl, tert-butyl, n-pentyl, isopentyl, neopentyl, tert-pentyl, hexyl, heptyl, octyl, nonyl, decyl, dodecyl, octadecyl, vinyl, allyl, cyclopentyl, cyclohexyl, cycloheptyl, methyl cyclohexyl, phenyl, naphthyl, anthryl, phenanthryl; o-, m-, p-tolyl, xylyl, ethylphenyl, benzyl, and α- and β-phenylethyl.

7. The process of claim 5 wherein said low viscosity non-volatile polysiloxanes have the structure of Formula II 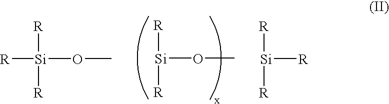
where R, which are the same or different, are monovalent hydrocarbon radical and x is an integer from 75 to 700.

8. The process of claim 7 wherein in said low viscosity non-volatile polysiloxane structure of Formula II, R comprise alkyl radicals selected from the group consisting of methyl, ethyl, n-propyl, isopropyl, n-butyl, isobutyl, tert-butyl, n-pentyl, isopentyl, neopentyl, tert-pentyl, hexyl, heptyl, octyl, nonyl, decyl, dodecyl, octadecyl, vinyl, allyl, cyclopentyl, cyclohexyl, cycloheptyl, methyl cyclohexyl, phenyl, naphthyl, anthryl, phenanthryl; o-, m-, p-tolyl, xylyl, ethylphenyl, benzyl, and α- and β-phenylethyl.

9. The process of claim 1 wherein at least one polysiloxane has a viscosity of 60,000 mPa·s to 1,000,000 mPa·s.

10. The process of claim 1 wherein at least one polysiloxane has a viscosity of 100,000 mPa·s to 600,000 mPa·s.

11. A process of claim 1, wherein at least one polysiloxane has a viscosity in the range of 100 mPa·s to 5,000 mPa·s.

12. A process of claim 1, wherein at least one polysiloxane has a viscosity in the range of 350 mPa·s to 2,000 mPa·s.

13. The process of claim 1 wherein the silicone is a blend of at least one viscous silicone oil of a viscosity of 60,000 mPa·s to 1,000,000 mPa·s and at least one low viscosity silicone oil with a viscosity of 100 mPa·s to 5,000 mPa·s, and wherein the ratio of the viscous silicone oil to the low viscosity silicone oil is from 20:80 to 80:20.

14. The process of claim 13 wherein the ratio is from 50:50 to 70:30.

15. The process of claim 1 wherein the viscosity of the blended silicone oil is from 30,000 mPa·s to 100,000 mPa·s.

16. The process of claim 1, wherein at least one functional non-volatile polysiloxane is present, and has the structure of the Formula III 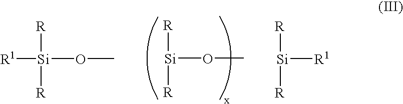
where R¹ is selected from the group consisting of amino-functional groups containing at least one carbon atom; carbonyl-functional groups containing at least one carbon atom; glycol-functional groups containing at least one carbon atom; epoxy-functional groups containing at least one carbon atom; acryloxy-functional groups; chloroalkyl-functional groups; vinyl-functional groups and functional groups having the formula X—R²— where X is a functional group containing one atom which is not a carbon atom or hydrogen atom, R² is an alkylene group having at least one carbon atom, and x is an integer from 10-100.

17. The process of claim 16 wherein in said Formula III, R¹ group is selected from the group consisting of:

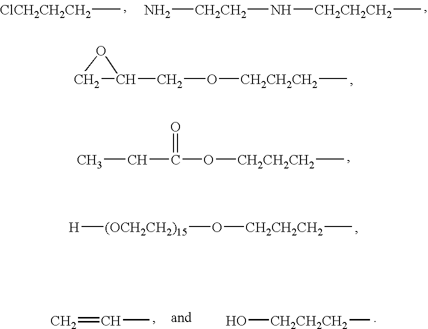

18. The process of claim 1 wherein said process comprises mixing silicone oil, surfactant, thickener and water at a temperature of at least 55° C., and after uniformly dispersing the thickener, cooling the mixture to 20-40° C. and continuing stirring at a temperature of 30-35° C. until a targeted viscosity of the emulsion is reached; adding a second emulsifier and continuing stirring at a temperature of 30-35° C. until the viscosity of the emulsion drops to a second targeted viscosity, and diluting the resulting emulsion with water to form a high particle size emulsion having particle sizes in the range of 1-100 microns average (D50).

19. The process of claim 1 wherein the processing in steps (i) and (ii) are carried out at more than 50° C. at atmospheric pressure, and after dispersing surfactant and thickener in the fluid, the mixture is cooled to 20-40° C., the rest of the mixing process being carried out at 30-35° C. at atmospheric pressure.

20. The process according to anyone of claim 1 wherein the components are mixed in a low shear mixer.

21. The process of claim 1 wherein at least one non-ionic surfactant having an HLB value of 4.0-9.5 is selected from the group consisting of polyoxyalkylene alkyl ethers, polyoxyalkylene alkylphenyl ethers, and polyoxyalkylene sorbitan esters.

22. The process of claim 1 wherein said anionic thickener is a suspending agent for the emulsion.

23. The process of claim 1 wherein the anionic thickener comprises a polycarboxylic acid polymer.

24. A process for the manufacture of stable and high particle size silicone emulsions comprising:
In a first stage, providing a silicone oil/blend in a mixing tank in an amount of 50-70% of the weight of the emulsion, adding 10-30% water, a non-ionic emulsifier having an HLB value 4.0-9.5 in an amount of 1-10% of the emulsion, or adding emulsifier such that a ratio of 20-30:1 of fluid to emulsifier is reached, adding 0.1 to 1% thickener; heating all components while mixing to the range of 55° C.-70° C. and continuing stirring for a period of 0.5-3 hr until the emulsifier and thickener disperse in the system, cooling the mixture to 20-40° C. and continuing mixing, until a targeted viscosity of the water-oil-surfactant-thickener in the range of 70,000 to 1,500,000 cps is achieved over a period of 2-5 hr, and
in a second stage, adding 0.5% to 5% or an amount of emulsifier to achieve a ratio of 40-45:1 of fluid to emulsifier, said emulsifier having an HLB value of 4.0 to 9.5, continuing mixing at 30-35° C. until a second targeted viscosity in the range of 20,000 to 65,000 cps is achieved over a period of not more than 1-3 hr, and after the second targeted viscosity is achieved, adding water for final dilution, and biocide in the range of 0.01 to 0.05% of the emulsion.
